(19) United States
(12) Patent Application Publication
(10) Pub. No.: US 2006/0029310 A1
(43) Pub. Date: Feb. 9, 2006

(54) Loadbearing platform with fluid support, isolation and rotation

(75) Inventors: Rick C. White, Nashua, NH (US); Keith Pope, Merrimack, NH (US); David J. Mount, Andover, MA (US); Laura Rothman, South Kent, CT (US); Clifton Busby, Georges Mills, NH (US); Raymond J. Dow III, Amherst, NH (US)

Correspondence Address: MAINE & ASMUS, 100 MAIN STREET, P O BOX 3445, NASHUA, NH, 03061-3445, US

(73) Assignee: S.C. FLUIDS, INC., Nashua, NH (US)

(21) Appl. No.: 11/098,992

(22) Filed: Apr. 5, 2005

Related U.S. Application Data
(63) Continuation-in-part of application No. 10/818,548, filed on Apr. 5, 2004.
(60) Provisional application No. 60/559,512, filed on Apr. 5, 2004.
(60) Provisional application No. 60/460,133, filed on Apr. 3, 2003.

(51) Int. Cl. F16C 32/06

(52) U.S. Cl. 384/100

(57) ABSTRACT

Device for fluidic support and bi-directional rotation of an item in a process chamber where the operating fluid is compatible with the process. The device has a rotable load bearing platform with a load bearing interface between it and a base in the chamber. Fluid, which may be supercritical fluid, is applied through load bearing ports into the interface to fluidly support the weight and create rotational forces on the load platform. A turbine on the load platform is actuated by fluid flow directed from turbine ports in the chamber connected to the fluid source. Markers on the load platform and sensors in the chamber provide speed and direction sensing. An electromagnetic source in the chamber reacts with a permanent magnet in the rotable platform to provide an electromagnetic force for moving, or changing or holding the relative position of the load platform.

This application relates and claims priority to pending U.S. application Ser. No. 60/559,512, filed Apr. 5, 2004; and is a continuation-in-part application to pending U.S. application Ser. No. 10/818,548, also filed Apr. 5, 2004.

### FIELD OF THE INVENTION

The invention relates to fluid propelled rotational platforms and toolheads; and more particularly to process fluid injection and workpiece/toolhead rotational propulsion systems within process chambers.

### BACKGROUND OF THE INVENTION

The fluid treatment or processing of workpieces such as silicon wafers and substrates for photovoltaic or electronic applications requires special equipment and handling in order to contain the fluid, the process, and the waste materials. The fluid treatment or processing of all types of articles, irrespective of material, may require special equipment and handling, particularly if the fluid or the process byproducts are toxic or the process or treatment requires elevated temperatures or pressures or other environmentally challenging variables and conditions.

Process chambers in which the article, the process, and the byproducts can be contained during the execution of the process, typically in a batch process or subprocess mode, are commonly used in many industries. The process chambers may be constructed and configured for inserting the workpiece or article in advance of, concurrently with, or after the process fluid is introduced. In high pressure, high temperature applications such as supercritical fluid processes, the chamber is opened to receive the workpiece and then sealed. The process fluid is then admitted through ports connecting to a source of process fluid. Heat and pressure are controlled by various means.

Agitation of the process fluid and/or the workpiece may be accomplished by various means including the geometry of the chamber and injection port as to their effects on fluid flow dynamics; arrangements of fluid nozzles to direct process fluid against the workpiece, and rotation or other cyclic or oscillatory movement of either the workpiece, the nozzles, or of an agitator affecting fluid motion.

The byproducts in some processes may be accumulated in the chamber and removed after the process is complete, although in supercritical processing of silicon wafers for photovoltaic and electronic applications, it is common to inject the process fluid in one port while exhausting it from another, so as to bathe or wash the wafer with a continuing source of fresh process fluid for as long as deemed necessary. The process may include soaking periods during which the flow is halted and the workpiece is simply allowed to soak in the process fluid for further penetration and effect.

As noted above, in many industrial applications, rotation of the workpiece or of an agitator or tool head is a desirable component of the process. The rotor component must overcome the resistance of the fluid as a part of its “work”, of course, but there is another factor that, while in many more benign processes is insignificant, becomes important in some cases.

The intentional rotating of a mechanical structure is never 100% efficient as between the source of torque and the rotor structure, whatever it may be. Friction between moving and stationary parts is often detrimental in a number of ways. It wastes energy, creates heat, and shortens the useful life of equipment. To ameliorate the effects of friction, lubricants and coatings have been developed that, as a result of desirable chemical or physical properties, act as a buffer between parts and diminish the effects of friction.

In applications where a high degree of cleanliness is required, such approaches are untenable, as the lubricants themselves may become contaminants. Similarly in such applications, the environment may be hostile, preventing the use of solid, friction reducing coatings, such as the popular Polytetrafluoroethylene, which may degrade and contaminate the process. Even in the absence of such material, the abrasion of metal surfaces may result in debris and contaminants.

Such requirements for cleanliness are especially stringent in the supercritical processing and cleaning of such components as circuit boards, micro electromechanical devices, and semiconductor wafers. In these processes it is often helpful to agitate, stir or rotate the process fluid or the workpiece itself. Such actions must be taken, however, within a closed pressure chamber and without introducing or creating contaminants to the pressure chamber.

What is needed, therefore, are techniques for minimizing frictional resistance while introducing rotational movement to a mechanically closed environment.

### BRIEF SUMMARY OF THE INVENTION

One object of the invention is to provide a device for fluid support and rotational propulsion of an item. To that end one aspect of the invention provides for a rotable load platform having a bearing interface with a non-rotable base; a plurality of fluid bearing ports associated with the base proximate the load bearing interface between the platform and the base; and the fluid bearing ports being connectible to a source of fluid at elevated pressure so as to fluidly lift and rotationally support the load platform with respect to the base by the pressure and flow of the fluid.

This aspect provides further at least one turbine coupled to the load platform; and a plurality of fluid turbine ports associated with the base proximate the turbine. The fluid turbine ports are connectible to a source of fluid at elevated pressure and directed at the turbine so as to apply rotational torque to the platform by the flow of fluid.

Another object of the invention is to possess a method for providing rotation of a load platform within a process chamber. To this end, one aspect of the invention includes: admitting a source of fluid under pressure into a horizontal bearing interface between a load platform and the chamber so as to float the load platform on the fluid, the fluid flowing from the horizontal bearing interface into the chamber; and also admitting a source of fluid under pressure into a rotational or shaft bearing interface between the load platform and the chamber so as to provide fluidic rotational or shaft support of the load platform, the fluid flowing from the shaft bearing interface into the chamber.

This aspect also includes: admitting a source of fluid under pressure into an interface between a rotational turbine on the load platform and an array of fluid turbine ports so as to apply rotational torque to the load platform, the fluid flowing from the turbine interface into the chamber; discharging the fluid from the chamber; and controlling the admitting and discharging of the fluid so as to maintain a pressure differential between the fluid under pressure and the chamber.

Yet another object of the invention is to provide a system for processing an article in a fluid. To this end, one aspect of the invention includes a process chamber and control system connectible to a source of process fluid at high pressure and to a receiver of process byproducts. There is a rotable load platform within the process chamber that has a load bearing interface between it and the chamber, and means for securing an article to the platform. The load bearing interface is open and connected for fluid flow to the chamber when high pressure fluid is injected into the interface.

There is a plurality of fluid bearing ports associated with process chamber proximate the load bearing interface, where the fluid bearing ports are connectible to and supplied by a source of fluid at high pressure whereby a fluid flow in the bearing ports is controllable by the control system so as to fluidly float and rotationally support the load platform by the pressure and flow of the fluid through said load bearing interface into the chamber.

There is at least one turbine coupled to the load platform, and the discharge end or region of the turbine is connected for spent fluid flow to the chamber. There is a plurality of fluid turbine ports associated with the process chamber proximate the turbine, connectible to and supplied by a source of fluid at high pressure and directed at the turbine whereby a fluid flow in the turbine ports is controllable by the control system so as to apply rotational torque to the load platform by the pressure and flow of the fluid to the turbine, which then flows into the chamber.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view illustrating a fluid driven rotary device configured in accordance with one embodiment of the present invention.

FIG. 2 is an exploded perspective view illustrating a fluid driven rotary device configured in accordance with one embodiment of the present invention.

FIG. 3A is a bottom planar view illustrating a fluid driven rotary device configured in accordance with one embodiment of the present invention.

FIG. 3B is a cross sectional elevation view illustrating a fluid driven rotary device configured in accordance with one embodiment of the present invention.

FIG. 4 is a block diagram illustrating a fluid circuit implementing a fluid driven rotary device configured in accordance with one embodiment of the present invention.

FIG. 5A is a perspective view illustrating a fluid actuated rotary load bearing platform configured in accordance with one embodiment of the present invention.

FIG. 5B is a perspective view illustrating a non-rotatable core or base for use in a fluid operated lifting and rotating platform device configured in accordance with one embodiment of the present invention.

FIG. 5C is a detail perspective view illustrating a non-rotatable core for use in a fluid actuated lifting and rotating platform device configured in accordance with one embodiment of the present invention.

FIG. 6 is a cross section view illustrating with dashed lines the bearing and turbine ports supplying fluid under pressure to selected bearing and turbine interfaces for lifting, centering and rotating the rotable structure within a closed process chamber, where the load platform and process cavity is at the lower end of the rotable structure.

### DETAILED DESCRIPTION OF THE INVENTION

The invention as described and illustrated herein is susceptible of many embodiments. Those described in this section are merely exemplary, and not exhaustive of the scope of the appended claims.

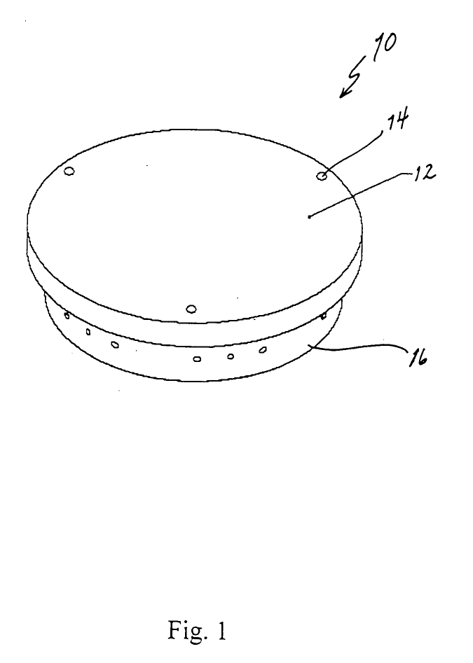

FIG. 1 is a prospective view of a fluid driven rotary device 10, which might also be characterized as a fluid powered motor or turbine engine, configured according to one embodiment of the present invention. The fluid driven rotary device comprises a horizontally disposed, rotable, load bearing platform 12. There is at least one mounting locus 14 thereon, and a stationary bearing collar or base 16. Loadbearing platform 12 may be alternatively characterized as a tool, or toolhead to which a process tool such as a fluid agitator may be attached. Mounting loci 14 may comprise structures, stubs, apertures, keyed slots or holes or other specific structural variation in the surface geometry of the load bearing surface wherein clips, pins, or fasteners may be disposed, or workpieces or tools attached. Alternatively, mounting loci 14 may comprise clips, fasteners, vacuum sources, or other such means whereby a load may be temporarily or permanently fixed to the surface of the load bearing platform 12.

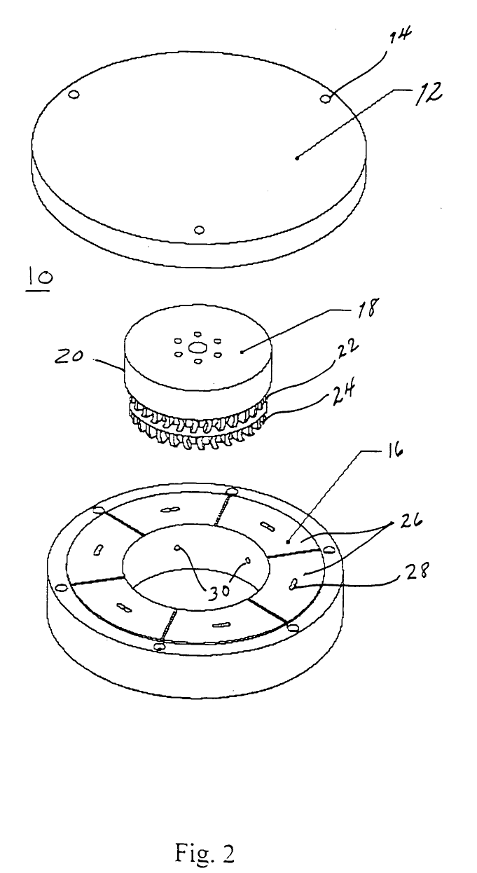

The mechanism by which one embodiment of the present invention is actuated is illustrated in FIG. 2, which is an exploded prospective view of a fluid driven rotary device configured according to one embodiment of the present invention. Beneath load bearing platform 12 there is axially disposed a vertically oriented journal shaft 18 of smaller diameter than platform 12. The underside surface of platform 12 (not shown) is an otherwise substantially planar, upper bearing surface, smoothly finished. Journal shaft 18 functions as the rotor component of device 10. This journal shaft 18 provides a centering surface 20, and first and second unidirectional turbines 22, 24. Upon application of a tangentially directed high pressure fluid flow vertically aligned with, and flowing in the appropriate direction for the turbine blade configuration, the first turbine 22 provides clockwise torque tending to cause clockwise acceleration and/or clockwise rotation.

Under corresponding conditions, the second turbine 24 provides counterclockwise torque tending to cause counterclockwise acceleration or rotation. Thus, switching or balancing of these opposing direction tangential fluid flows provides a basis for control of speed and direction of rotation of platform 12.

The available fluid pressure and flow in each direction is preferably adequate to at least sustain meaningful rotation under process conditions at a useful speed, or alternatively to reduce the speed of counter-rotation as in a braking or speed control scenario.

It should be noted that a single, bi-directional turbine may be used in lieu of the two, uni-directional turbines 22 and 24, for bi-directional fluid flow and rotation based solely or partly on the selected direction, pressure, or balance of the tangential fluid flows.

Journal shaft 18 with its turbines attached is configured to be disposed within the axial bore of bearing collar 16, which is also functionally the stator in this fluid powered motor. The bearing collar or base 16 comprises a plurality of radially arranged sectors 26 sharing a common plane comprising the surface of the base and the lower bearing surface of the vertical supporting fluid bearing mechanism of device 10.

During no-flow conditions, load platform 12 normally rests directly on the bearing surface of sectors 26. Each sector 26 provides at least one levitation fluid port 28. In operation, fluid is directed through each levitation fluid port 28. The resulting pressure differential between the upper and lower surfaces of the load bearing platform 12, causes the load bearing platform 12 to rise and ride on the fluid flow from the levitation fluid port 28. Also disposed within the bearing collar 16 are drive ports 30. The drive ports 30 are arrayed in two vertically displaced subsets, (not distinguished in the figures), so as to direct fluid flow to either the first or second turbines 22, 24. Drive ports 30 directed to the first turbine 22 drive the load bearing platform 12 in a clockwise rotation, while those drive ports 30 directed towards the second turbine 24 drive the load bearing platform 12 in a counter clockwise rotation. During concurrent fluid bearing lift and centering, frictional resistance to rotation comprises mainly fluid friction.

The device 10, thus described, operates as a fluid driven or hydraulically driven motor with fluid vertical and radial bearing benefits and fluid isolation of rotating and stationary components. Spent fluid is exhausted through the fluid gap between base 16 and load platform 12. Sectors 26 may be divided by grooves that facilitate migration and uniform distribution of fluid from the core to the periphery of device 10.

The operation of device 10 in any or all modes of fluid bearing and rotation results in a pressure drop between the fluid source and the fluid exhausted from device 10. It is assumed for the proceeding description and required for fluid levitation and fluid centering and rotation of device 10 that ports 28 and at least one of the subsets of ports 30 are connected via a fluid flow control system to a source of fluid at high pressure, and that fluid emitted from device 10 is not so constrained so as to cause excessive back pressure. This is necessary so that a predictable pressure differential is maintained between the source and the ambient pressure within which device 10 is operated.

For example, an open hood process chamber operated at ambient pressure and having a reservoir for accumulating byproduct fluids will require only a constant pressure source of fluid to operate the fluid powered aspects of device 10. The actual process to which the workpiece is being subjected may not involve the fluid at all.

However, a closed pressure vessel process chamber within which a device 10 is operated, where a process fluid or supercritical fluid is required to contact a workpiece or wafer secured to load platform 12, may, for example, utilize a process fluid connection to base 16 as either the sole source or as a supplemental source of process fluid to the process chamber. A control system for such a process including operation of device 10 must include coordination and control of an exhaust port or ports in the chamber to maintain the correct chamber pressure as well as the pressure differential required to operate device 10. The general design of such process control systems is understood, and only routine calculations and experimentation relating to a specific process, pressure chamber and device 10 design is required to produce a suitable control system.

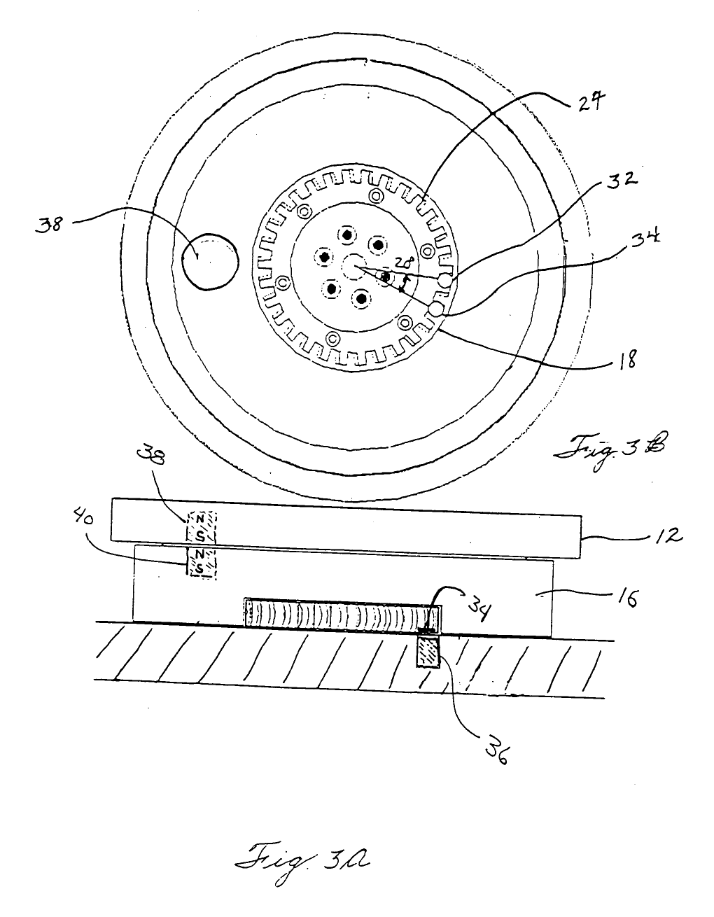

FIG. 3A illustrates a bottom planar view of a fluid driven rotary device configured according to one embodiment of the present invention. Disposed within the journal shaft 18, distinguishable first and second sensor targets 32, 34 are arrayed with a radially displaced angle of other than 180 degrees; in this embodiment, about 20°, though one skilled in the art would readily appreciate that other angles are equally well adapted to this purpose. Means of distinguishing the first and second targets may include disposition of identical targets at detectably different radii, or by other commonly known means.

As is readily understood, one target would be sufficient to determine speed, but without a distinctive head and tail orientation detectable at passage, it would not be sufficient, alone, to provide directional information. Conversely, a single target with a detectable head and tail orientation would be sufficient to determine both speed and direction.

As the two sensor targets 32, 34 pass over at least one sensor 36 in sequence, the speed and direction of the load bearing is monitored by the sensor 36 disposed in the support structure beneath the device 10, and connected to a control system. Sensor 36, illustrated in FIG. 3B, comprises, according to one embodiment, commercial, off the shelf, a laser reflector sensor. One skilled in the art will readily appreciate that other sensors capable of recognizing targets would be equally suitable. The term sensor and target are meant here to define and include any non-contact marking mechanism or scheme by which a point on one part is detectable with respect to its relatively close proximity or passage near a point on another part.

Disposed within the underside of load platform 12 is a brake target 38, illustrated with broken lines as being within platform 12. The brake target 38 is provided to facilitate the stopping of rotation and precise rotational positioning and holding in position of the load bearing platform 12. According to one embodiment this target is composed of a ferrous material, or other material having a suitable magnetic dipole moment. Disposed within base 16, and illustrated by broken lines, is an electromagnet 40 which may be activated as required by a control system. The attraction between the electromagnet 40 and the brake target 38 arrests the movement of the load bearing platform 12, overcoming the inertia of the device, and bringing the device to rest, and may be operated such that the resting or stopping point is precisely predetermined with respect to its rotational orientation, a useful feature for loading and unloading of platform 12. The braking and holding mechanism may be configured to provide single, stepped or variable resistance to rotation for braking, up to very high resistance to any movement as during loading.

More complex timing and switching control circuitry in conjunction with a suitable array of targets 38 and rotor-like windings matched to a stator-like array of electromagnets 40 can be used alone or with the fluid turbine power and fluid levitation described to support or accelerate rotation of platform 12, in the manner of an electric motor with all fluid bearing support and rotor isolation.

There may also be configurations of bearing interface between the load platform or rotor of the invention and the bearing base or stator of the invention, other than the described simple combination of horizontal planar for vertical lift, and vertical wall journal shaft for radial support and centering. For example, the journal shaft and underside of platform 12 may have a cone shape or other more complex shape providing both vertical and radial components, mated with a base receiver of corresponding profile. Turbine functionality may be incorporated as a ring of radially arranged blades set in or attached to a horizontal zone of the interface, where the tangential fluid flow directed at the blades has a component of vertical direction that contributes to lift for the load platform. Alternatively, the turbine section may be broadly or narrowly distributed at other than an exclusively horizontal plane or vertical wall surface of the bearing interface.

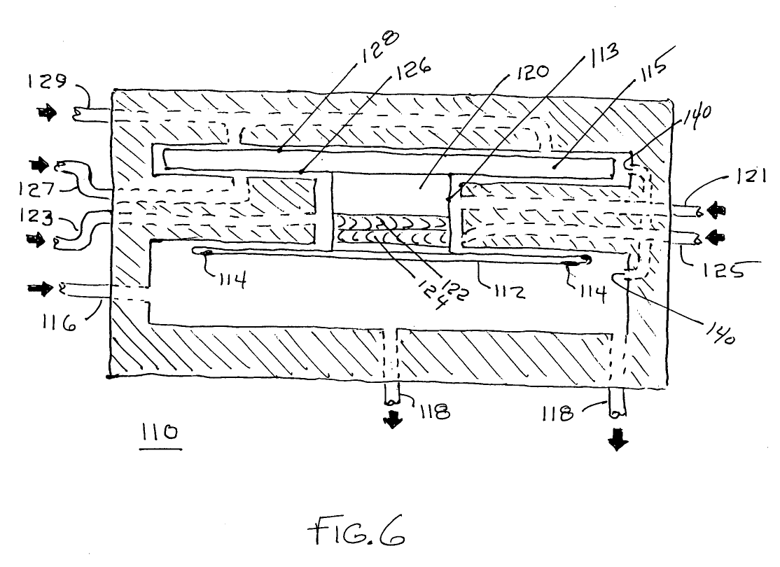

Other and further structure may be incorporated into device 10, for further purposes, such as providing a groove in the journal shaft and a locking ring or pin extending inward from base 16, or other interlocking structure as illustrated in FIG. 6, to provide a limit to the vertical range of motion of platform 12 with respect to base 16. The vertical limit structure may likewise be configured for fluid flow lubrication and isolation in the manner described for the bearing interface.

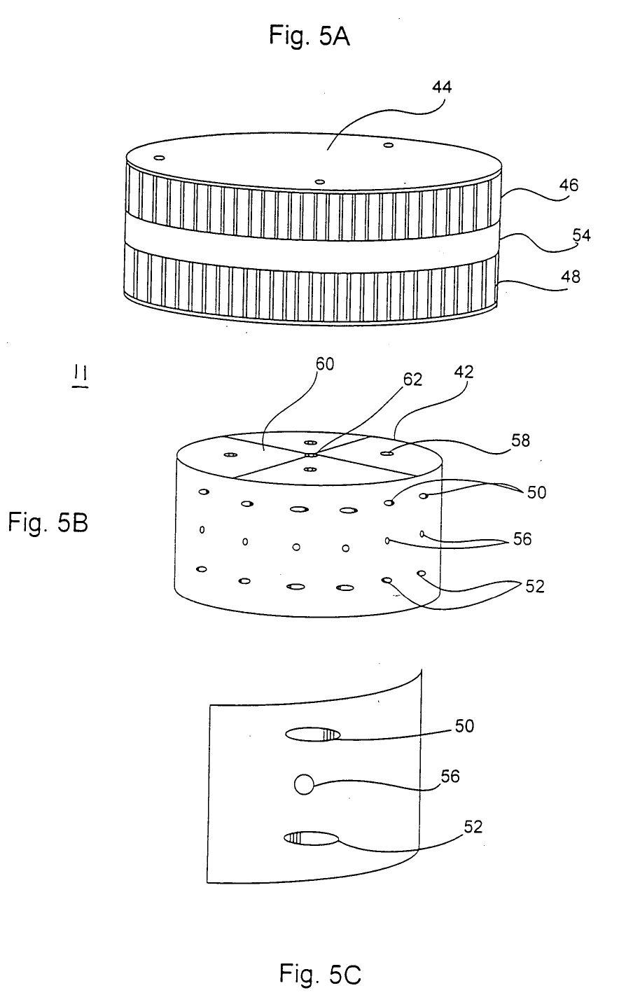

FIGS. 5A-5C illustrate one embodiment of a fluid driven rotary device 11 having a stationary, non-rotatable or stator-like core shaft 42, illustrated in FIG. 5B, upon which is disposed a load bearing platform 44, illustrated in FIG. 5A, which has integrated first and second turbines 46, 48 configured as a skirt-like structure extending downward from the periphery of platform 44 as an external, circumferential, closely conforming shroud around core shaft 42. The interior underside (not shown) of platform 44 is a planar horizontal bearing surface of smooth finish. In one such embodiment, rotational force is applied to the load bearing platform 44 by the application of fluid streams from core shaft 42 to the first and second turbines 46,48, with the direction of the applied rotational torque, either clock wise or counter clockwise, being governed by the angle of the respective turbine blades and the orientation of the fluid flow apertures. The fluid flow streams, as illustrated in the exploded view of the non-rotatable core in FIG. 5C, are directed either through clockwise or counterclockwise directional control apertures 50,52. The clockwise and counter clockwise directional control apertures 50,52, may, according to one embodiment, be disposed at nearly tangential angles to the surface of the shaft 42, directing the force of the high pressure fluid against the blades of the respective turbine. The control apertures 50,52 may be vertically displaced on the wall of the shaft 42 such that a directional control aperture 50,52 is aligned with either the first or second turbines 46,48.

The load bearing platform 44 is provided with a platform centering collar 54 as an integral part of the downward extending skirt-like structure that includes the turbines. This platform centering collar 54, may in one embodiment be disposed between the first and second turbines, while other embodiments may provide one or more such collar 54 disposed in an alternative positions including above and below the turbines. This collar 54, in combination with fluid flow from a plurality of platform centering fluid apertures 56, acts in an analogous way to a traditional fluid bearing, centering the shaft 42 within the load bearing platform 44, in an approximately friction free fashion. The vertical height of the one or more collars may vary as to be greater or less than the vertical height of the turbines, depending on the required bearing surface area required for centering and isolation versus the turbine surface area required for providing rotational torque.

The load bearing platform 44 is lifted or levitated by fluid flow directed through levitation apertures 58 disposed in the top surface 60 of the shaft 42. These levitation apertures 58 direct fluid towards the underside of the load bearing platform 44. This fluid induced a pressure differential between the top and bottom of the load bearing platform 44. This pressure differential counteracts gravitational or other forces applied to the load bearing platform 44, lifting the platform 44 and providing a rotationally friction free (except for fluid friction) bearing. According to one embodiment, each levitation aperture 58 is disposed within a segment of the top surface 60 of the shaft 42. This segmentation of the surface is configured to avoid turbulence and uneven distribution of the fluid, which would result in unsteadiness in the load bearing surface 44. Some embodiments may provide a fluid sink 62 disposed in the center of the top surface 60. This sink provides a means for removing excess fluid from the region above the top surface without fluid escaping through the first turbine 46 and resulting in rotational force, even when undesired. Alternative means for preventing such undesired rotational torque may include careful balancing of clockwise and counter clockwise fluid flows, even when no rotation is required, or the application of magnetic attraction from a stopping means as described above.

As in earlier described embodiments, variations on the structure, geometry, and further included functionality of device 11 are within the scope of the invention. For example, device 10 and 11, while depicted and described as having a vertical axis of rotation, may be configured and operated with a horizontal axis of rotation or any angle in between.

In the case of a horizontal axis of rotation of the load platform, it will be readily apparent that the vertical component of fluid support for the load platform, in addition to centering support, must be born by the rotational bearing interface, as by the journal shaft wall 20 of device 10 or the inner wall of collar 54 of device 11. While relative dimensions may require adjustment, all necessary structure components for horizontal axis operation, including travel limits for axial movement of the load platform, have been described herein.

Further embodiments include other variations such as load platforms at either end of a common journal shaft in a horizontal axis of rotation; and a lift platform on the upper end of a vertical journal shaft with a downward facing load platform on the lower end of the journal shaft, as in FIG. 6.

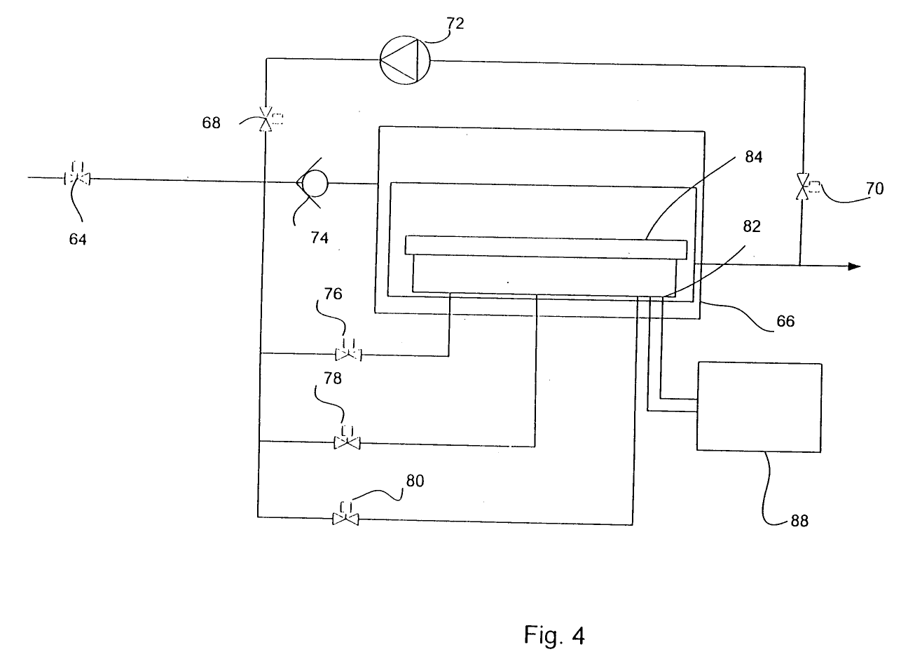

Illustrated in FIG. 4, is a diagram of a fluid flow circuit employing one embodiment of a fluid driven rotary device 10, also applicable to device 11 and other embodiments such as those described above. A common fluid source is provided through a fluid inlet valve 64. While in one embodiment a single fluid source is employed, other embodiments, wherein a variety of fluids may be employed, thereby effecting changes in chemistry or in other desirable attributes of the system during a process, will be readily appreciated to be within the scope of the present invention by one skilled in the art.

According to one embodiment, the device 10 is employed in a process chamber 66. Such process chambers are employed in supercritical cleaning of semiconductor work pieces, and other processes conducted in elevated pressure and temperature regimes. In such systems, process fluid capture and recirculation subsystems may be provided comprising recirculation valves 68, 70 and recirculation pumps 72, whereby exhausted fluid may be reintroduced to the process chamber. In this embodiment, a portion of the process fluid admitted at fluid inlet valve 64 is used as the actuator fluid for device 10. To maintain a pressure differential necessary for the operation of the device 10, fluid is, according to one embodiment introduced at a lower setpoint pressure to the chamber through a check valve 74. Control valves 76,78, 80 are provided for the operation of device 10. Directional control valves 76, 80 admit fluid into the device through the directional control apertures or drive ports 30,50,52 described in detail above. This fluid may be supplied at full pressure or may be adjusted to obtain a desired speed or direction of rotational movement. Fluid is also supplied to the device through the levitation control valve 78. Fluid thus supplied is directed through the levitation ports or levitation apertures 28, 58.

The sensors 82 disposed within the process chamber 66 may measure the temperature, pressure, and composition of the fluid in the chamber 66 and/or the speed and direction of rotation of the load bearing platform 84. This information is then relayed to a controller 86.

Referring again to FIGS. 3A, 3B, and 4 controller 86 receives inputs from sensors 82, 36, enabling speed and rotation reporting and control (control lines omitted for clarity) of speed and rotation by operation of valves 68, 70, 76, 78, 80 and operation of electromagnetic homing circuit 38, 40 for asserting home position for the wafer support platform. Controller 86 may be a local controller, station computer, or integrated function of a central computer system.

In order to maintain proper pressure differential for the varying fluid flow requirements of operating device 10 in conjunction with desired process chamber pressure, maximum chamber fluid pressure and exhaust fluid outflow may be controlled by a chamber fluid discharge check valve or control valve, while fluid inlet pressures may be adjusted correspondingly to maintain minimum chamber pressure, either manually, by check valve or by means of computer controlled sensors. In addition or alternatively, available fluid pressure and flow delivered to device 10 may be controlled so as to yield a spent fluid discharge into the chamber at appropriate pressure. In any event, process control is a well developed art, and once the objectives as described herein are understood, those skilled in the art will be able to provide control systems adequate to the requirement.

Referring now to FIG. 6, device 110 is an embodiment of the invention similar in some aspects to device 10 of FIG. 2, however it is here integrated into a process chamber, and provides for a downward facing load platform to which a tool or workpiece may be attached. While illustrated with vertical axis orientation, as described above, the device may be configured for horizontal axis orientation as well.

Rotable load platform 112 is a planar surface attached to one end, in this case the lower end, of journal shaft 113, and lift platform 115 is attached to the other end, in this case the upper end, of shaft 113. These three components comprise the movable structural which fluid under pressure may be used to fluidly lift, center, isolate, and rotate a workpiece or tool within the chamber. With reference to other than vertical axis orientations, the term “lifting” as opposed to rotating means linear motion normal to the plane of rotation.

The lift platform is confined within an upper section of the process chamber where the injection of fluid at high pressure through fluid bearing port 127 is applied to interface 126 and thereby tends to lift and float the rotable structure vertically off the chamber's base structure. Vertical travel is, however, fluidly limited by the application of fluid under pressure through fluid bearing port 129 into interface 128. It will be further appreciated that an intentional axial movement or reciprocating plunging motion can be conducted with a device of the invention, Bypass 140 on the periphery of the chamber permits high pressure fluid flow out of the vertical lift and limit upper section into the lower section of the chamber and hence to outlet ports 118.

Fluid under pressure admitted at fluid bearing port 121 is applied to centering interface 113 on journal shaft 120 for axial centering and isolating of the rotable structure. Fluid under pressure admitted to fluid turbine ports 123 and 125 and directed to turbines 122 and 124 respectively provide for the application of clockwise and counterclockwise rotational torque which can be used for accelerating, maintaining, or slowing rotation in either direction as described previously. Spent fluid from these activities migrates into the lower section of the chamber.

Wafers, workpieces, cassettes, or tools such as fluid agitators may be attached to load platform 112 at locus points 114. Process fluid is admitted to the chamber at process fluid inlet port 116, and exhausted at outlet ports 118.

An appropriate radial and angular distribution of ports is assumed for balance of applied fluid forces. Tolerances at bearing interfaces are a function of chamber design criteria and process variables including physical dimensions, desired rotational and axial motion parameters, temperatures and pressures, fluid viscosity, fluid pressure/flow ratios, and control system dynamics. It is implicit in the closed chamber process of this embodiment that the actuator fluid by which lift, centering and rotation are achieved, is the process fluid, or is the same as or compatible with the process fluid and the process. Appropriate valves and control system sensors are likewise assumed.

Various embodiments and examples of the invention may employ various fluids, in liquid, gaseous, or supercritical states, as a means of propulsion and/or levitation, each having relative advantages and disadvantages. According to one such embodiment, a supercritical fluid such as supercritical carbon dioxide may be used, either alone, or in combination with various additives whereby advantageous processing chemical environments may be obtained.

One example of the invention is a device for fluid support and rotational propulsion of an item, consisting of a rotable load platform having a bearing interface with a non-rotable base where the two opposing surfaces are in a weight or force bearing, sliding relationship of one against the other. There is a plurality of fluid bearing ports associated with the base proximate the bearing interface, and the fluid bearing ports are connectible to a source of fluid at elevated pressure so as to fluidly lift and rotationally support the load platform with respect to the base by the pressure and flow of the high pressure fluid.

There is also at least one turbine coupled to or incorporated with the load platform, and a plurality of fluid turbine ports associated with the base proximate the turbine. The fluid turbine ports are connectible to the same or a different source of fluid at elevated pressure and directed at the turbine so as to apply rotational torque to the platform by the flow of the fluid.

The load platform may be configured with ties, clips or fasteners of any kind for securing an article thereto. The device may be located within a process chamber that has a door or hatch or is in some way openable so that the article can be admitted and removed after processing of the article is complete. The chamber may have a fluid outlet for exhausting the spent fluid. The chamber may have a process control system controlling fluid pressure and flow in at least the fluid bearing ports, the fluid turbine ports and the fluid outlet so as to both maintain the desired chamber pressure as well as the necessary pressure differential to operate the device.

There may be a first marker associated with the rotable load platform, and a marker sensor associated with the base, where the rotational path of the first marker passes in close proximity to the marker sensor, which is connectible to a control system for monitoring at least the speed of rotation of the load platform, and direction as well if the marker is directionally readable or if there is a second marker distinguishable from the first marker and angularly displaced at other than 180 degrees.

There may be an electromagnet associated with the base of the device and connectible to a control system, and a permanent magnet associated with the rotable load platform such that the path of rotation of the permanent magnet passes in close proximity to the electromagnet. The electromagnet may be connectible to a control system for exerting an electromagnetic force on said load platform, whether rotationally or axially in direction or component so as to hold in place or cause lateral motion, lift, or a related change of position.

The turbine may consist of clockwise and counterclockwise turbines, and the fluid turbine ports be clockwise and counterclockwise directed fluid turbine ports, where the fluid turbine ports are connected for rotation control to a process chamber control system. There may be a centering collar attached to the load platform where the turbines are disposed on the centering collar.

Another example of the invention is a method for providing rotation of a load platform within a process chamber, which includes: admitting a first source of fluid under pressure into a horizontal bearing interface between the load platform and the supporting structure within the chamber so as to float the load platform on fluid, the fluid flowing as a result from the horizontal bearing interface into the chamber; and admitting the same or a second source of fluid under pressure into a rotational or shaft bearing interface between the load platform and the supporting structure of the chamber so as to provide fluidic shaft or axial support of the load platform for rotation, the fluid flowing as a result from the shaft bearing interface into the chamber.

It further includes admitting the same or another or a third source of fluid under pressure into a rotational turbine interface between the turbine on the load platform and the closest or most proximate structure of the chamber to the turbine so as to apply rotational torque to the turbine and hence to the load platform, the fluid flowing as a result from the turbine interface into the chamber; discharging the fluid from the chamber; and controlling the admitting and discharging of fluid so as to maintain a pressure differential between the source of the fluid under pressure and the chamber.

According to this example, the axis of rotation of the load platform may be horizontal and the shaft bearing interface may include by design sufficient surface area to provide the required horizontal component of bearing interface. The fluid may be in supercritical phase or it may be carbon dioxide or both.

A further example of the invention is a system for processing an article in a fluid, consisting of a process chamber and control system connectible to a source of process fluid at high pressure and to a receiver of process byproducts. It has a rotable load platform within the process chamber that has a load bearing interface in the process chamber. The load platform is configured for securing one or more articles to it for processing. And the load bearing interface is held open and connected for fluid flow to the chamber whenever fluid under pressure is applied to the load platform.

As in the other examples and embodiments described herein, there are a plurality of fluid bearing ports associated with the base or process chamber, as opposed to the load platform, which terminate at and open into or communicate for fluid flow into the load bearing interface. These fluid bearing ports are routed back through chamber structure as conduits to an exterior connection on the chamber that is connectible via the control system and associated valves and plumbing to the source of fluid at high pressure whereby a fluid flow emitting from the bearing ports is controllable by the control system so as to fluidly float and rotationally support the load platform by use of the pressure and flow of the fluid into and through the load bearing interface and hence into the chamber or other fluid or process byproducts receiver.

Switching valves, check valves, heaters, fluid mixers, electrical leads, sensor leads, and other control and process devices may be incorporated into the chamber and system design.

There is at least one turbine coupled to the load platform, and as in all the examples and embodiments described herein it is configured so that there will be a path for spent fluid to flow from the turbine region into the chamber or other fluid or process byproducts receiver. The turbine is a circular array of blades or vanes configured to convert an axial or circular fluid flow into a rotational mechanical force, which in this case is applied to the load platform. While an axial fluid flow configuration of the turbine and turbine ports is within the scope of the invention, a circular fluid flow for turbine actuation is preferred due to the preferred device and chamber geometry.

In this example, there is a plurality of fluid turbine ports associated with the process chamber in the region of the turbine so that they terminate or open for fluid flow with a close, high pressure, directionally oriented, circular fluid flow stream into the turbine blades. The turbine ports are preferably uniformly distributed around the turbine so as to create a uniformly high turbine pressure with fluid flow. The fluid turbine ports are connectible through conduits in the base or chamber structure to external connections, to associated control valves, to the source of fluid at high pressure. Fluid flow directed through the ports at the turbine is controllable by the control system so as to apply rotational torque in the desired amount, in the desired direction, to the load platform by the pressure and flow of the fluid. The spent fluid then flows from the turbine region to the chamber or other fluid or process byproducts receiver.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, nor by the exemplary claims appended hereto.

We claim:

1. A device for fluid support and rotational propulsion of an item, comprising:
a rotable load platform having a bearing interface with a non-rotable base;
a plurality of fluid bearing ports associated with said base proximate said bearing interface, said fluid bearing ports connectible to a source of fluid at elevated pressure so as to fluidly lift and rotationally support said load platform with respect to said base by the pressure and flow of said fluid;
at least one turbine coupled to said load platform; and
a plurality of fluid turbine ports associated with said base proximate said turbine, said fluid turbine ports connectible to a said source of fluid at elevated pressure and directed at said turbine so as to apply rotational torque to said platform by the flow of said fluid.

2. The device according to claim 1, said load platform configured for securing an article thereto.

3. The device according to claim 3, located within a process chamber, said chamber configured with means for admitting and removing said article.

4. The device according to claim 3, said fluid comprising supercritical fluid.

5. The device according to claim 3, said fluid comprising carbon dioxide.

6. The device according to claim 3, said chamber comprising a fluid outlet.

7. The device according to claim 6, said chamber comprising a process control system controlling fluid pressure and flow in at least said fluid bearing ports, said fluid turbine ports and said fluid outlet.

8. The device according to claim 1, the axis of said rotable load platform being vertically oriented.

9. The device according to claim 1, the axis of said rotable load platform being horizontally oriented.

10. The device according to claim 8, said rotable load platform and said base together comprising a horizontal, planar, bearing interface and a shaft bearing interface.

11. The device according to claim 1, further comprising:
a first marker associated with said rotable load platform; and
a marker sensor associated with said base, the rotational path of said first marker passing in close proximity to said marker sensor, said marker sensor being connectible to a control system for monitoring at least the speed of rotation of said load platform.

12. The device according to claim 11, further comprising:
a second marker distinguishable from said first mark and angularly displaced at other than 180 degrees.

13. The device according to claim 1, further comprising:
an electromagnet associated with said base and connectible to a control system; and
a permanent magnet associated with said rotable load platform such that the path of rotation of said permanent magnet passes in close proximity to said electromagnet, said electromagnet being connectible to a control system for exerting an electromagnetic force on said load platform.

14. The device according to claim 3, said turbine comprising clockwise and counterclockwise turbines; said fluid turbine ports comprising clockwise and counterclockwise directed fluid turbine ports, said fluid turbine ports connected to a process chamber control system.

15. The device according to claim 1 further comprising a journal shaft attached to said load platform, wherein said turbines are disposed on said journal shaft.

16. The device according to claim 1 further comprising a centering collar attached to said load platform wherein said turbines are disposed on said centering collar.

17. A method for providing rotation of a load platform within a process chamber comprising:
admitting a first source of fluid under pressure into a horizontal bearing interface between said load platform and said chamber so as to float said load platform on said fluid, said fluid flowing from said horizontal bearing interface into said chamber;
admitting a second source of fluid under pressure into a shaft bearing interface between said load platform and said chamber so as to provide fluidic shaft support of said load platform, said fluid flowing from said shaft bearing interface into said chamber;
admitting a third source of fluid under pressure into a rotational turbine interface on said load platform so as to apply rotational torque thereto, said fluid flowing from said turbine interface into said chamber;
discharging said fluid from said chamber; and
controlling said admitting and said discharging of said fluid so as to maintain a pressure differential between said fluid under pressure and said chamber.

18. The method according to claim 17, whereas the axis of rotation of said load platform is horizontal and said shaft bearing interface comprises said horizontal bearing interface

19. The method according to claim 17, said first, second and third sources of fluid under pressure controlled by a process chamber control system and coming from a common source of fluid.

20. The method according to claim 17, said fluid comprising supercritical fluid.

21. The method according to claim 17, said fluid comprising carbon dioxide.

22. A system for processing an article in a fluid, comprising:
a process chamber and control system connectible to a source of process fluid at high pressure and to a receiver of process byproducts;
a rotable load platform within said process chamber having a load bearing interface in said process chamber, said load platform configured with means for securing said article thereto, said load bearing interface connected for fluid flow to said chamber;
a plurality of fluid bearing ports associated with said process chamber proximate said load bearing interface, said fluid bearing ports connectible to said source of fluid at high pressure whereby a fluid flow in said bearing ports is controllable by said control system so as to fluidly float and rotationally support said load platform by the pressure and flow of said fluid through said load bearing interface into said chamber;
at least one turbine coupled to said load platform, said turbine connected for fluid flow to said chamber; and
a plurality of fluid turbine ports associated with said process chamber proximate said turbine, said fluid turbine ports connectible to said source of fluid at high pressure and directed at said turbine whereby a fluid flow in said turbine ports is controllable by said control system so as to apply rotational torque to said load platform by the pressure and flow of said fluid to said turbine and hence to said chamber.

23. The system according to claim 22, said chamber configured with means for admitting and removing said article.

24. The system according to claim 22, said fluid comprising supercritical fluid.

25. The device according to claim 22, said fluid comprising carbon dioxide.

26. The system according to claim 22, further comprising:
a first marker associated with said load platform; and
a marker sensor associated with said process chamber such that the rotational path of said first marker passes in close proximity to said marker sensor, said marker sensor being connectible to said control system for monitoring at least the speed of rotation.
